(19) United States
(12) Patent Application Publication
(10) Pub. No.: US 2014/0111717 A1
(43) Pub. Date: Apr. 24, 2014

(54) DRIVE SCHEME FOR CHOLESTERIC LIQUID CRYSTAL DISPLAY DEVICE

(71) Applicant: Christopher John Hughes, Woodley (GB)

(72) Inventor: Christopher John Hughes, Woodley (GB)

(73) Assignee: VERSATILE TECHNOLOGIES LTD, Neve Ilan (IL)

(21) Appl. No.: 14/128,204

(22) PCT Filed: Jun. 25, 2012
(86) PCT No.: PCT/GB2012/051482

§ 371 Date: Dec. 20, 2013

(30) Foreign Application Priority Data
Jun. 29, 2011 (GB) 1111123.4

(51) Int. Cl. G02F 1/133

(52) U.S. Cl. CPC G02F 1/13306
USPC 349/33

(57) ABSTRACT

A drive scheme for a cholesteric liquid crystal display device comprises supply of a drive signal to the electrode arrangement of a cell comprising a layer of cholesteric liquid crystal material. The drive signal comprises at least one initial pulse that drives the cholesteric liquid crystal material into the homeotropic state; a relaxation period that allows the cholesteric liquid crystal material to relax into the planar state; and a drive sequence during which the root mean square voltage of the drive signal, determined over periods within which the cholesteric liquid crystal does not relax, increases monotonically. The drive sequence reduces the reflectivity of the cholesteric liquid material without any fluctuations.

The present invention relates to driving of a cholesteric liquid crystal display device which typically comprises at least one cell comprising a layer of cholesteric liquid crystal material and an electrode arrangement capable of applying a drive signal across at least one area of the layer of cholesteric liquid crystal material.

Known drive schemes drive the cholesteric liquid crystal material into different states to vary the reflectivity and hence the brightness and colour of the display device. One common approach is to drive the cholesteric liquid crystal material into its stable states, that is the planar state in which the cholesteric liquid crystal material is reflective to provide a bright state, the focal conic state in which the cholesteric liquid crystal material is transmissive to provide a dark state (when arranged in front of a dark background), and often also mixture states to provide grey levels of intermediate brightness.

Various drive schemes for driving the cholesteric liquid crystal material into the stable states are known. Such drive schemes usually provide fluctuations in brightness, perceived by the viewer as a ‘blink’ or a ‘flash’ at the transition from one state to the next state. Such a fluctuation occurs because the drive schemes involve supply of one or more initial pulses that drive the cholesteric liquid crystal material into the homeotropic state and then after a short pause the supply of one or more selection pulses that drive the cholesteric liquid crystal material into the selected state, often with a relaxation period therebetween.

The unstable homeotropic state is the most transmissive state and so the initial pulse(s) briefly provide a low brightness, which is perceived as a dark ‘blink’ before the cholesteric liquid crystal material is driven into the stable state by the selection pulse(s). A relaxation period is provided between the initial pulse(s) and the selection pulse(s), which causes the cholesteric liquid crystal material to relax into the planar state, which is perceived as a period of brightness (a bright ‘blink’) intermediate the dark ‘blink’ of the initial pulse(s) and the selection pulse(s).

Lastly, after removal of the selection pulse(s) that produce a grey level, the cholesteric liquid crystal material relaxes under the elastic forces causing the reflectivity to increase slightly, which is perceived as yet a further fluctuation, or ‘bounce’, in the brightness. To illustrate this effect, FIG. 2 shows a scope trace for selection pulses 108 and the resultant optical response, measured using a photodiode, of a typical cholesteric liquid display device. After removal of the selection pulses 108, the reflectivity exhibits an increase with the elastic response time of the liquid crystal material and therefore demonstrates the undesirable ‘bounce’.

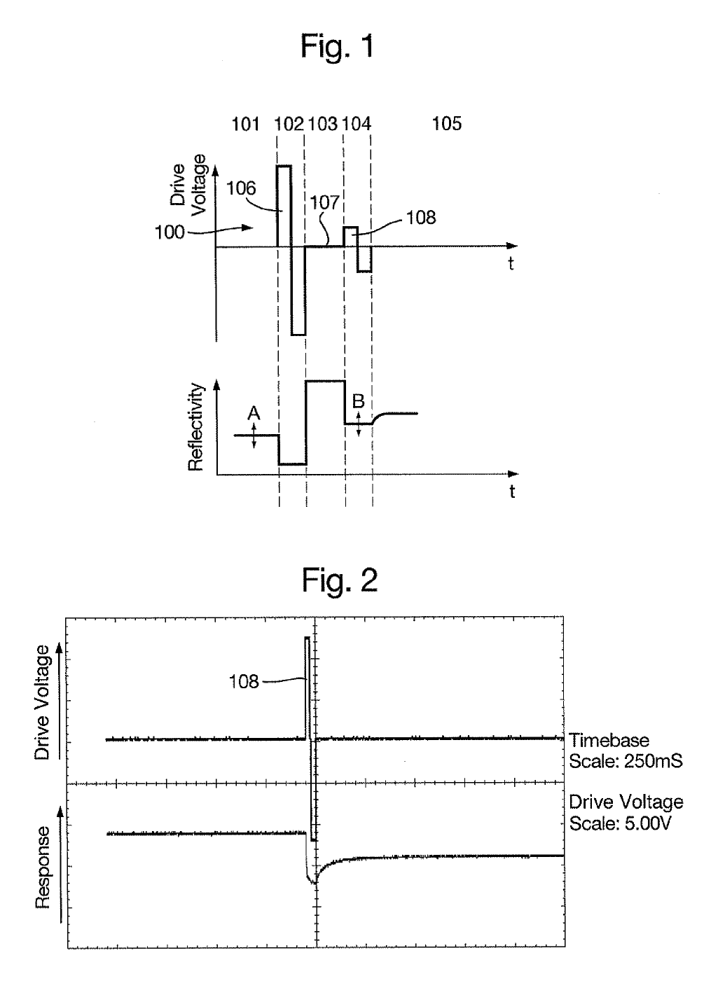

To illustrate this fluctuation, an example of a typical drive scheme is shown in FIG. 1, together with the resultant reflectivity on the same time scale. Successive time periods are labeled 101 to 105. The drive signal 100 consists of: two dc-balanced initial pulses 106 in period 102 that drive the cholesteric liquid crystal material into the homeotropic state; a relaxation period 107 in period 103, typically of length 20-100 ms, that allows the cholesteric liquid crystal material to relax into the planar state; and two dc-balanced selection pulses 108 that drive the cholesteric liquid crystal material into a selected one of the stable states. This drive signal causes a change in reflectivity as follows. In period 101 before application of the drive signal, the cholesteric liquid crystal material is in a stable state having any arbitrary reflectivity as shown by the arrow A. In period 102, the reflectivity of the homeotropic state is low being lower than that of any stable state. In period 103, the reflectivity of the planar state is high, being at maximum for the material. In period 104, the reflectivity varies depending on the selected stable state as shown by the arrow B, but is reduced from that of period 103. In period 105, the relaxation of the cholesteric liquid crystal material causes an increase in the reflectivity compared to period 104.

Thus, when changing the reflectivity from the level in period 101 to the final level in period 105, there is a fluctuation in brightness perceived as a very dark ‘blink’ (period 102), a bright ‘flash’ (period 103), and finally a dark ‘bounce’ (period 104) before the reflectivity settles at its final level.

When the cholesteric liquid crystal display device is used to display a static image, this fluctuation is generally considered acceptable, because it occurs only as a transition when the image is refreshed. Once the relaxation has occurred in period 105, the cholesteric liquid crystal material remains in the selected stable state for a long period of time and there is no further change in reflectivity until the image is refreshed.

The present invention is concerned with applications in which it is desired to provide a series of changes from a bright state to a dark state via grey levels. In such applications, fluctuation in reflectivity such as occurs with the type of known drive scheme described above is undesirable. One non-limitative example of such an application is when the cholesteric liquid crystal display device is used as a decorative tile. In this case, the fluctuation is distracting or even annoying to the viewer. It would therefore be desirable to develop a drive scheme providing a change from a bright state to a dark state without fluctuations occurring at the transitions between grey levels.

According to a first aspect of the present invention, there is provided a method of driving a cholesteric liquid crystal display device which comprises at least one cell comprising a layer of cholesteric liquid crystal material and an electrode arrangement capable of applying a drive signal across at least one area of the layer of cholesteric liquid crystal material, the method comprising supplying a drive signal to the electrode arrangement that comprises:

at least one initial pulse that drives the cholesteric liquid crystal material into the homeotropic state;

a relaxation period that allows the cholesteric liquid crystal material to relax into the planar state; and

a drive sequence during which the root mean square voltage of the drive signal, determined over periods within which the cholesteric liquid crystal does not relax, increases monotonically and correspondingly reduces the reflectivity of the cholesteric liquid material.

This drive signal has been found to provide a change from a bright state to a dark state without fluctuations. This occurs as follows.

The at least one initial pulse drives the cholesteric liquid crystal material into the homeotropic state and the relaxation period allows the cholesteric liquid crystal material to relax into the planar state, in just the same way as some known drive schemes for example of the type shown in FIG. 1. Thereafter the drive sequence is applied. This can have a variety of forms, but has the property that its root mean square voltage, determined over periods within which the cholesteric liquid crystal does not relax, increases monotonically. As a result of the cholesteric liquid crystal not relaxing over these periods, the cholesteric liquid crystal material reacts to the root mean square voltage of the drive signal. It has been found that the increase in the root mean square voltage causes the reflectivity of the cholesteric liquid material to reduce.

The precise change in the state of the cholesteric liquid material is not fully understood, but it is observed that as the reflectivity reduces, the reflectivity spectrum maintains a peak at substantially the same wavelength as the planar state (although there is a slight shift). Furthermore, the reflectivity reduces in correspondence with the root mean square voltage of the drive signal, so reduces monotonically, that is without any fluctuation.

This avoids fluctuations that would be caused if the drive scheme shown in FIG. 1 were applied to drive a change from a bright state to a dark state through a series of grey levels. Although the at least one initial pulse and the relaxation period do cause a single fluctuation at the initial transition to the first bright state, thereafter there is no fluctuation at the subsequent transitions to dark states as the brightness reduces. As the subsequent transitions do not use an initial pulse or relaxation period, they avoid the very dark ‘blink’ (period 102) and the bright ‘flash’ (period 103). All the transitions, including the initial transition to the first bright state, also avoid the dark ‘bounce’ (period 104).

Desirably, the drive sequence comprises a sequence of pulses, which is easier to implement using digital techniques in a control circuit than using analogue techniques. In this case, between the pulses, there are no gaps or gaps sufficiently short that the cholesteric liquid crystal does not relax. Thus, the root mean square voltage of the pulses is determined over cycle periods of the pulses and increases monotonically.

The drive sequence of pulses may comprise a series of groups of a plural number of pulses, wherein the root mean square voltage of the pulses within each group is the same, and the root mean square voltage of the pulses of each successive group increases. By so grouping the pulses, the root mean square voltage increases in stepwise fashion for each group. This stepped change reduces the number of changes in the overall sequence and thereby simplifies the generation of the drive signal.

In one type of embodiment, the drive sequence may comprise a sequence of pulses between which there are no gaps, wherein the magnitude of the voltage of the pulses increases monotonically so that the root mean square voltage of the pulses, determined over cycle periods of the pulses, increases monotonically. In this type of embodiment, it is necessary to implement pulses of varying magnitudes, but the power consumption is minimized.

In one type of embodiment, the drive sequence may comprise a sequence of pulses between which there are gaps sufficiently short that the cholesteric liquid crystal does not relax, wherein the magnitude of the voltage of the pulses in the sequence is constant, the cycle period is constant and the width of the pulses increases monotonically so that the root mean square voltage of the pulses, determined over cycle periods of the pulses, increases monotonically. In this type of embodiment, it is possible to implement the drive sequence from pulses of the same magnitude which simplifies their generation, but the power consumption is increased.

According to a second aspect of the present invention, there is provided a cholesteric liquid crystal display device comprising: at least one cell comprising a layer of cholesteric liquid crystal material and an electrode arrangement capable of applying a drive signal across at least one area of the layer of cholesteric liquid crystal material; and a drive circuit arranged to supply a drive signal to the electrode arrangement similar to that of the first aspect.

To allow better understanding, an embodiment of the present invention will now be described by way of non-limitative example with reference to the accompanying drawings, in which:

FIG. 1 is a pair of graphs of drive voltage and reflectivity against time for a known drive scheme;

FIG. 2 is a pair of traces of drive voltage and reflectivity for an applied signal;

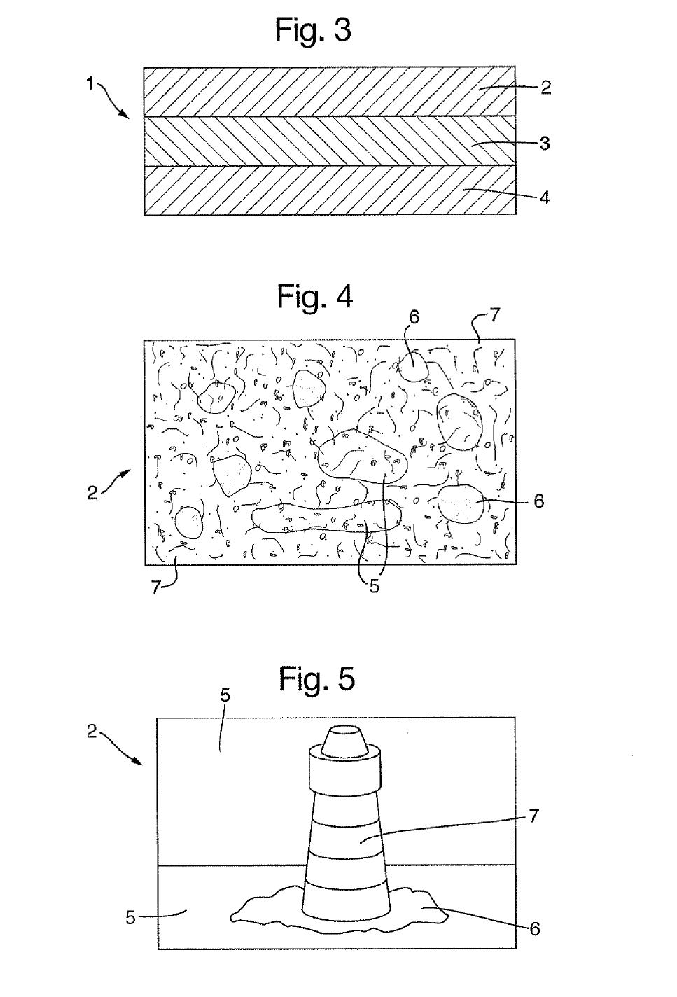

FIG. 3 is a cross-sectional view of a decorative tile;

FIG. 4 is a front view of a foreground image carried by the transparent front substrate of the decorative tile;

FIG. 5 is a front view of an alternative foreground image;

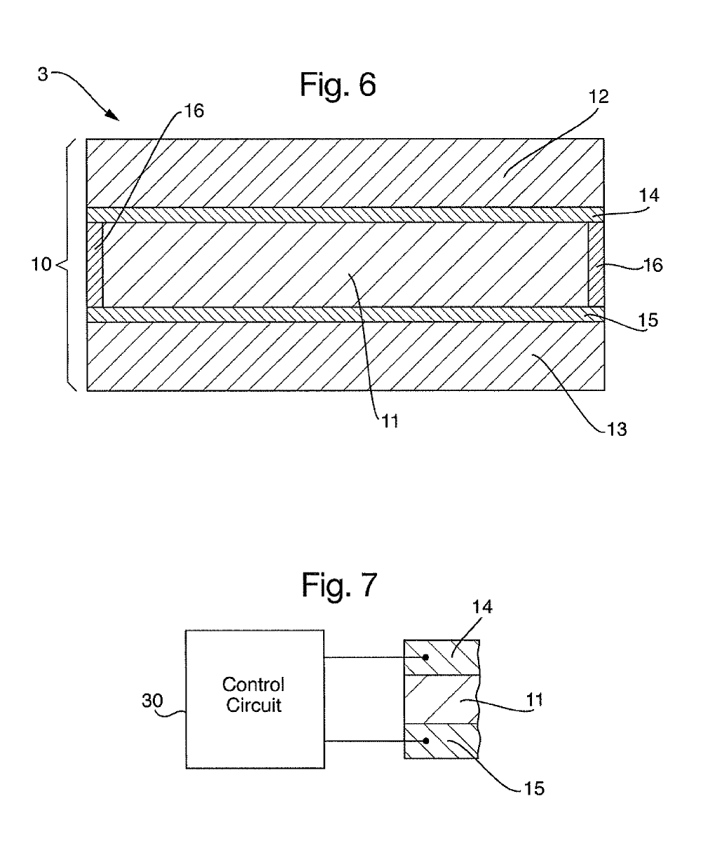

FIG. 6 is a cross-sectional view of a cholesteric liquid crystal display device of the decorative tile;

FIG. 7 is a diagram of a control circuit for the cholesteric liquid crystal display device;

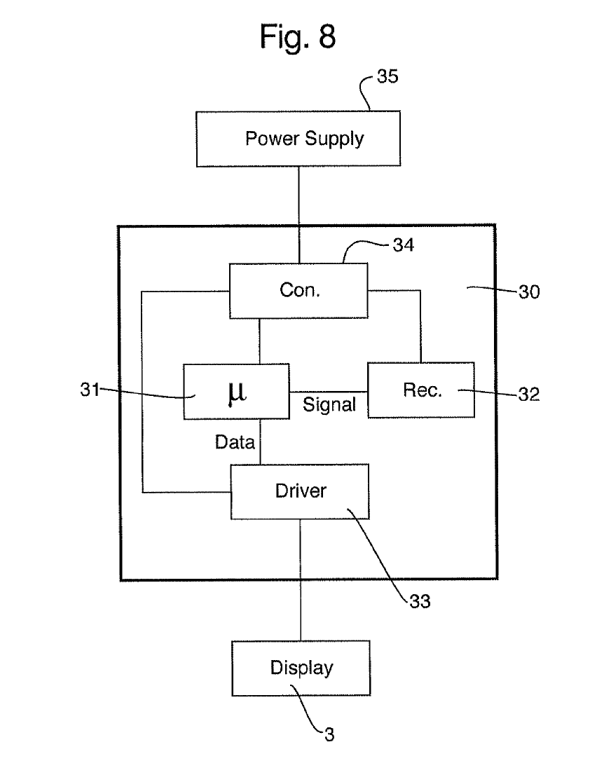

FIG. 8 is a block diagram of a possible implementation of the control circuit;

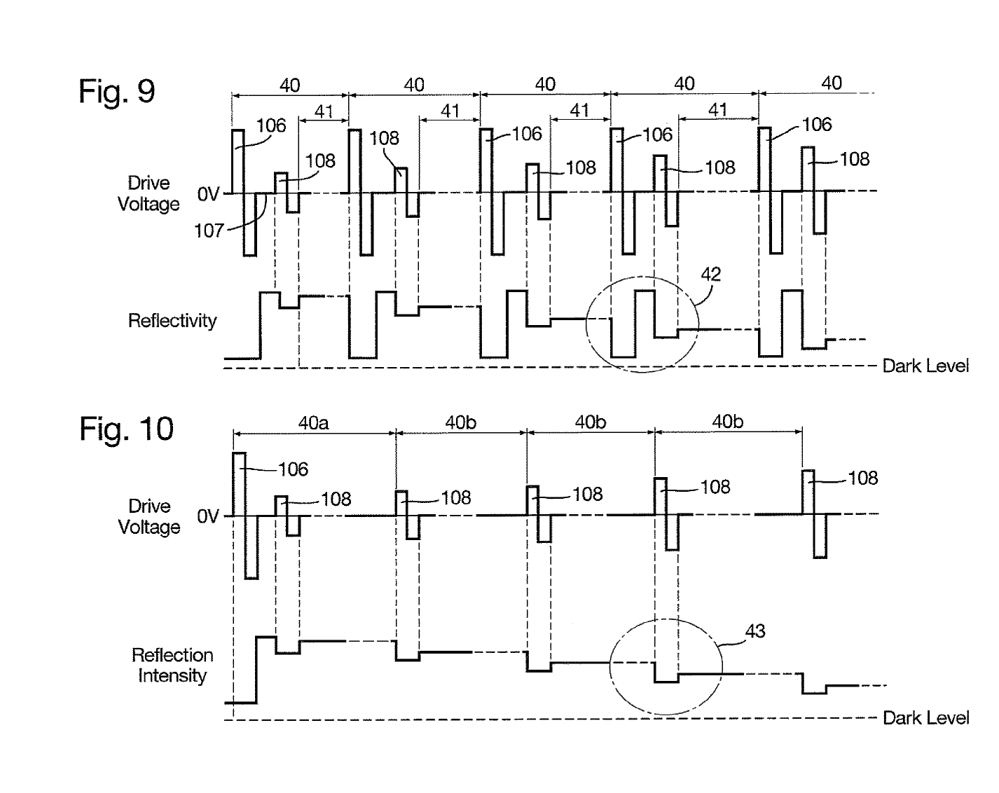

FIG. 9 is a pair of graphs of drive voltage and reflectivity against time for a known drive scheme applied to provide states of reducing brightness;

FIG. 10 is a pair of graphs of drive voltage and reflectivity against time for a drive scheme adapted from that of FIG. 9;

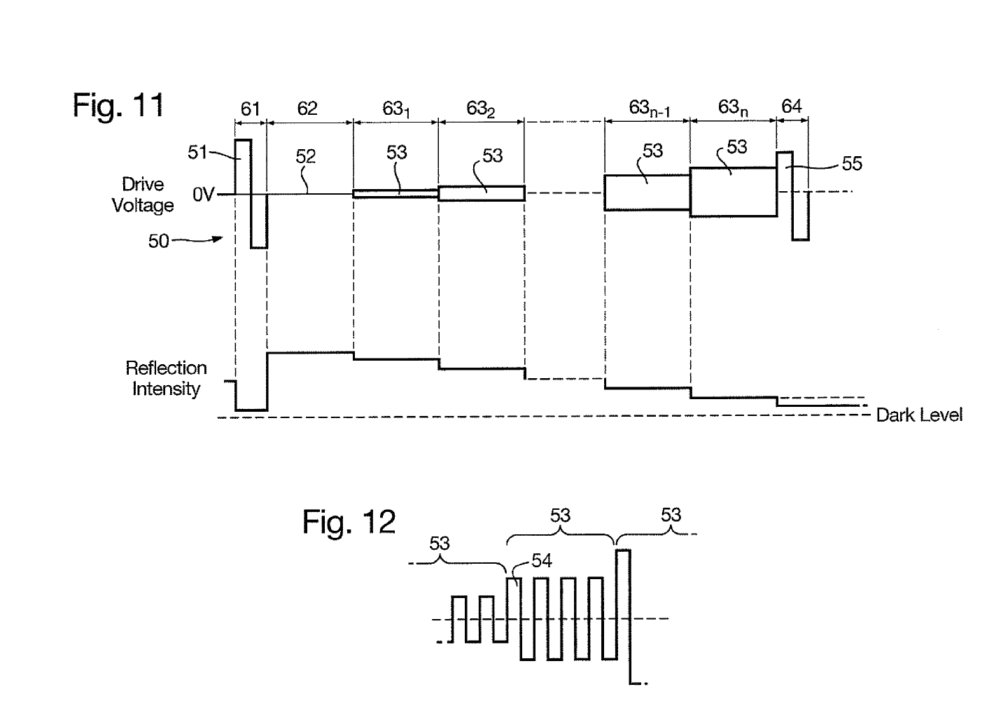

FIG. 11 is a pair of graphs of drive voltage and reflectivity against time for a drive scheme configured to provide states of reducing brightness;

FIG. 12 is a graph of drive voltage against time of part of the drive signal shown in FIG. 11;

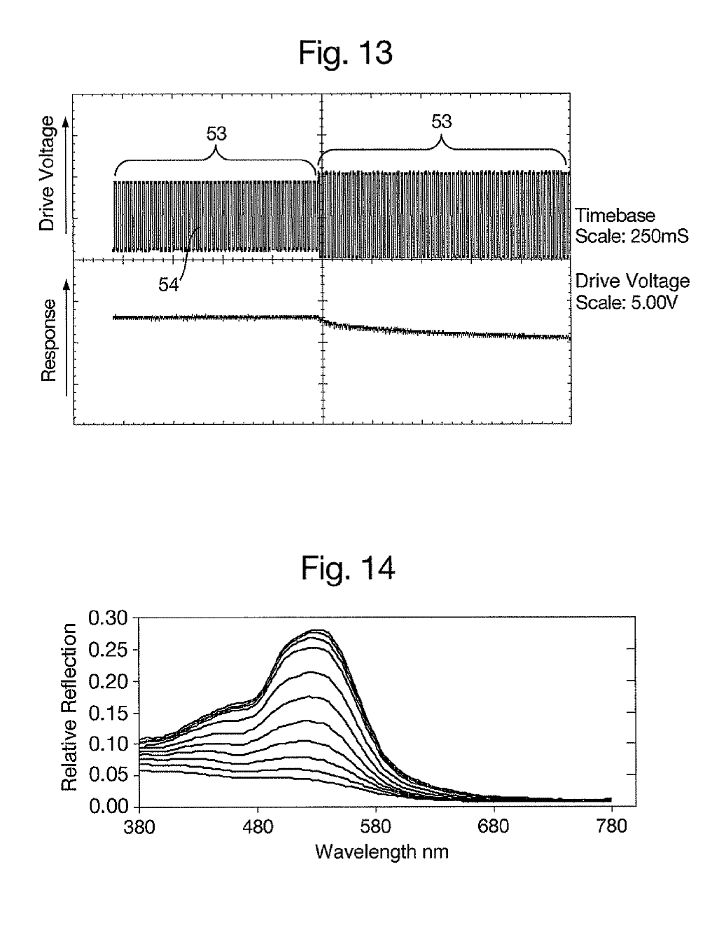

FIG. 13 is a pair of traces of drive voltage and reflectivity for an applied signal;

FIG. 14 is a graph of reflectivity against wavelength measured applying the drive signal of FIG. 1 with different selection pulses;

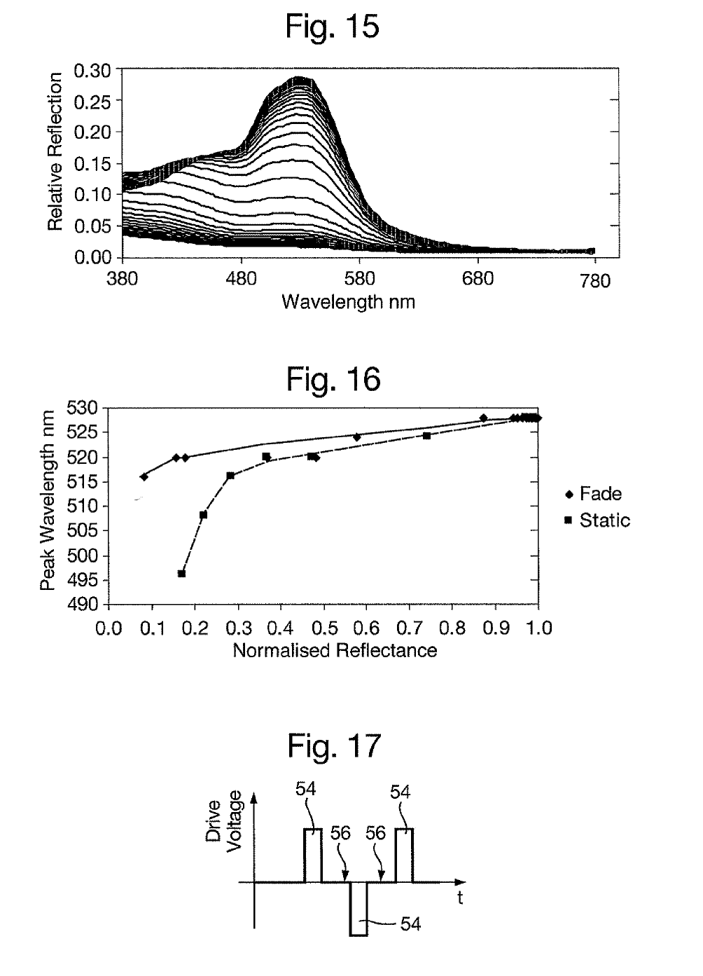

FIG. 15 is a graph of reflectivity against wavelength measured applying the drive signal of FIG. 11;

FIG. 16 is a graph of peak wavelength against reflectivity for the measurements of FIGS. 14 and 15; and

FIG. 17 is a graph of drive voltage against time of part of a modified form of the drive signal shown in FIG. 11.

There will first be described cholesteric liquid crystal display devices to which may be applied a drive scheme providing a change from a bright state to a dark state. Such a cholesteric liquid crystal display device may be of the type incorporated in a decorative tile as disclosed in British Application No. 1019213.6 which is incorporated herein by reference. An example of such a decorative tile 1 will now be described. British Application No. 1019213.6 describes further details of a decorative tile incorporating cholesteric liquid crystal that may be applied to the decorative tile 1 described herein. British Application No. 1019213.6 claims features of a decorative tile incorporating cholesteric liquid crystal that may be applied in any combination with the features of the invention claimed herein.

The decorative tile 1 is shown schematically in FIG. 3 and has a layered construction consisting of a cholesteric liquid crystal display device 3, a transparent front substrate 2 of the cholesteric liquid crystal display device 3 and a background layer 4 of the cholesteric liquid crystal display device 3 that are described further below and that are shown in FIG. 3 with a thickness that is exaggerated for clarity. The front of the decorative tile 1 from which it is viewed in normal use is uppermost in FIG. 3 so that the cholesteric liquid crystal display device 3 is behind the transparent front substrate 2 and the background layer 4 is behind the cholesteric liquid crystal display device 3.

First, the transparent front substrate 2 will be described. The transparent front substrate 2 carries a foreground image. The transparent front substrate 2 is ideally fully transparent as it is primarily a carrier for the foreground image, but this is not essential and it may have some degree of absorption provided that the layers below are not obscured.

The transparent front substrate 2 may be made from any suitable material, such as glass or plastic, and can have any suitable thickness, for example 2 to 12 mm.

The front surface of the transparent front substrate 2 may optionally be provided with an effect to improve the appearance of the decorative tile 1. In one example, the front surface of the transparent front substrate 2 may be treated, for example etched or blasted, to reduce its reflectance, thereby providing a softer and less reflective finish more like stone, or may be treated to provide an anti-glare effect, an anti-reflection effect, or a combination thereof.

The foreground image may conveniently be printed on the transparent front substrate 2, although it could be carried in other ways for example incorporated into the transparent front substrate 2. For the case of printing, a range of suitable printing techniques, such as screen, flexographic or inkjet printing, and a range of suitable inks are available for use. Typically, the printing technique might be a digital printing technique, for example using an ink-jet printer that may use for example ceramic UV or heat cure inks that can create opaque, semi-opaque or transparent regions.

After printing, a transparent front substrate 2 made of glass can be laminated to another layer such as glass to protect the print or strengthen (laminated glass) the glass if it has not been tempered during this process. The lamination can also contain UV blockers to protect the underlying layers.

Advantageously, the foreground image is printed on the rear of the transparent front substrate 2. This makes it easier to provide the front of the transparent front substrate 2 with an optional effect to improve the appearance of the decorative tile 1, for example, an anti-glare coating. This also protects the foreground image physically because it is inside the decorative tile 1, possibly avoiding the need to apply an additional protective layer.

The nature of the foreground image will now be discussed. The foreground image is passive, static and non-changing and has varying transparency across its area. The lower elements, in particular the cholesteric liquid crystal display device 3 and the background layer 4 are visible through these parts. The perception of the lower elements is complete at any parts that are fully transparent, but is modulated by the foreground image at any parts that are partially transparent. This effect may be used to vary the impact of the lower elements across the area of the decorative tile 1. Effectively, the foreground image being partially transparent can be used to provide grey levels in the appearance of the lower elements. Advantageously, the foreground image includes parts having different partial transparency, as this allows a textured appearance to be provided.

However, the precise nature of the foreground image, in particular what it is an image of, may be varied at the choice of the designer to provide a desired decorative effect.

In one type of decorative tile, the foreground image has the appearance of stone.

For example, FIG. 4 illustrates a possible foreground image on the transparent front substrate 2 having the appearance of natural stone, in this example including parts 5 that are not transparent, parts 6 that are partially transparent, and parts 7 that are fully transparent.

However, the foreground image having the appearance of stone is not limitative and the foreground image may take a variety of other forms, including an image of a scene (e.g. seascapes, landscapes and the like) or an object.

For example, FIG. 5 illustrates a possible foreground image on the transparent front substrate 2 that is an image of a scene including a lighthouse, in this example including parts 5 that are not transparent (e.g. the sea and sky), parts 6 that are partially transparent (e.g. the rocks on which the lighthouse stands), and parts 7 that are fully transparent (e.g. the walls of the lighthouse).

Next, the cholesteric liquid crystal display device 3 will be described. The purpose of the cholesteric liquid crystal display device 3 is to provide at least one layer of cholesteric liquid crystal material, being reflective material having a reflective property that is changeable in response to an external stimulus, that may be perceived through the parts of the foreground image that are fully or partially transparent. FIG. 6 illustrates a possible construction of the cholesteric liquid crystal display device 3 arranged as follows.

The cholesteric liquid crystal display device 3 comprises a single cell 10 incorporating a liquid crystal layer 11 of cholesteric liquid crystal material. The liquid crystal layer 11 is supported by two display substrates 12 and 13 arranged on opposite sides of the liquid crystal layer 11 to define therebetween a cavity in which the liquid crystal layer 11 is contained. The display substrates 12 and 13 are sufficiently rigid to support the liquid crystal layer 11, although they may have a degree of flexibility. For example, the display substrates 12 and 13 may be made of glass or plastic.

The liquid crystal layer 11 may be sealed in the cavity between the display substrates 12 and 13 by providing a peripheral seal 16, for example of glue, around the periphery of the liquid crystal layer 11. In this case, the foreground image may be designed so that the parts of the foreground image aligned with the peripheral seal are opaque (i.e. not transparent, whether by being absorptive or reflective or a combination thereof), so that the peripheral seal 16 is not visible.

Electrode layers 14 and 15 are disposed on the respective display substrates 12 and 13, in particular on the inner facing surfaces of the display substrates 12 and 13 between those display substrates 12 and 13 and the liquid crystal layer 11. The electrode layers 14 and 15 are transparent and conductive, being formed of a suitable transparent conductive material, typically indium tin oxide. As described further below, the electrode layers 14 and 15 may extend across part or all of the area of the cholesteric liquid crystal display device 3, and may be patterned to provide separate pixels.

Optionally, the electrode layers 14 and 15 may be overcoated, on the side adjacent to the liquid crystal layer 11, by one or more insulation layers (not shown), for example made of silicon dioxide.

Additionally or alternatively, the electrode layers 14 or 15 may be covered by respective alignment layers (not shown) formed adjacent to the liquid crystal layer 11 and covering the electrode layers 14 and 15 or the insulation layers if provided. Such alignment layers align and stabilise the liquid crystal layer and may typically be made of polyimide which may optionally be unidirectionally rubbed. As an alternative to such surface-stabilisation using alignment layers, the liquid crystal layer could be bulk-stabilised, for example using a polymer or a silica particle matrix.

The liquid crystal layer 11 has a thickness chosen to provide sufficient reflection of light, typically being in the range from 3 μm to 10 μm.

The liquid crystal layer 11 comprises cholesteric liquid crystal material. Such material has several physical states in which the reflectivity and transmissivity vary. The main states are the planar state, the focal conic state and the homeotropic (pseudo nematic) state, as described in I. Sage, Liquid Crystals Applications and Uses, Editor B Bahadur, Vol. 3, 1992, World Scientific, pp 301-343 which is incorporated herein by reference and the teachings of which may be applied to the present invention.

In the planar state, the liquid crystal layer 11 selectively reflects a bandwidth of light that is incident upon it. The reflectance spectrum of the liquid crystal layer 11 in the planar state typically has a central band of wavelengths in which the reflectance of light is substantially constant.

The wavelength of the reflected light is given by Bragg's law, i.e. λ=nP.cos θ, where n is the mean refractive index of the liquid crystal material seen by the light, P is the pitch length of the liquid crystal material and 0 is the angle from normal incidence. Thus, in principle, any colour can be reflected as a design choice by selection of the properties of the liquid crystal material, in particular the pitch length P. That being said, a number of further factors known to the skilled person may be taken into account to determine the exact colour.

The planar state is used as the bright state of the cholesteric liquid crystal display device 3 and the viewer sees the light reflected from the liquid crystal layer 11. When the liquid crystal material is in the planar state, light not reflected from the liquid crystal layer 11 is incident on the background layer 4. The background layer 4 is described further below, but if the background layer 4 is entirely absorptive (i.e. black), it absorbs substantially all the light incident thereon and the viewer sees just the light reflected from the liquid crystal layer 11. Similarly, if the background layer 4 is diffusively reflective with a non-uniform reflectance spectrum (i.e. coloured), it absorbs incident light of some wavelengths but reflects light of other wavelengths. The light reflected from the background layer 4 is seen by the viewer in addition to the light reflected from the liquid crystal layer 11 and may change the perceived colour.

In the focal conic state, the liquid crystal layer 11 is, relative to the planar state, transmissive and transmits incident light. All the incident light is incident on the background layer 4 which may absorb at least some of the incident light. When the liquid crystal layer 11 is in the focal conic state, the viewer sees any light reflected from the background layer 4 and thus perceives the cholesteric liquid crystal display device 3 as being of the colour of the background layer 4, this being a darker state than when the liquid crystal layer 11 is in the planar state.

The focal conic and planar states are stable states which can coexist when no drive signal is applied to the liquid crystal layer 11. Furthermore the liquid crystal layer 11 can exist in stable states in which different domains of the liquid crystal material are each in a respective one of the focal conic state and the planar state. These are sometimes referred to as mixture states. In these mixture states, the liquid crystal material has an average reflectance intermediate the reflectances of the focal conic and planar states. A range of such stable states is possible with different mixtures of the amount of liquid crystal in each of the focal conic and planar states so that the overall reflectance of the liquid crystal material varies, thus giving more than two different levels and in general a range of grey levels, although these are not necessarily used.

The focal conic, planar and mixed states are stable states that persist after the drive signal is removed. Thus after application of the drive signal to drive the liquid crystal layer 11 into one of the stable states, no further power is consumed.

In the homeotropic state, the liquid crystal layer 11 is even more transmissive than in the focal conic state, typically having a reflectance of the order of 0.6% or less. However, the homeotropic state is not stable and so maintenance of the homeotropic state would require continued application of a drive signal.

As an alternative to being formed by a single cell 10, the cholesteric liquid crystal display device 3 may comprise plural cells 10, each constructed as described above, stacked together in series. In this case each cell 10 may include a liquid crystal layer 11 that reflects a different part of the spectrum, so as to increase the colour gamut of the cholesteric liquid crystal display device 3.

Cholesteric liquid crystal material is therefore a reflective material that is changeable in response to an external stimulus in the form of an electrical signal. Thus, the reflectance may be changed by supply of such an electrical signal. The electrical signal may be supplied externally or from a control circuit that forms part of the decorative tile 1. As an example of this FIG. 7 illustrates the case where the decorative tile 1 comprises a control circuit 30 connected across the electrode layers 14 and 15 on opposite side of the liquid crystal layer 11 (the other layers of the cholesteric liquid crystal display device 3 being omitted in FIG. 7 for clarity). The control circuit 30 is arranged to generate drive signals for changing the state of the liquid crystal layer 11. The control circuit 30 and the form of the drive signal generated thereby are described further below.

The liquid crystal layer 11 may have reflective properties that are uniform across its area. However, additional decorative effects can be achieved if the liquid crystal layer 11 has reflective properties that are non-uniform across its area.

In one type of cholesteric liquid crystal display device 3, the reflective properties may be varied but subject to uniform change in response to an external stimulus. For example, this may be achieved by subdividing the liquid crystal layer 11 into parts of different cholesteric liquid material having different reflective properties, for example reflecting light of different colours.

In another type of cholesteric liquid crystal display device 3, the layer of reflective material may have areas that have reflective properties that are independently changeable in response to an external stimulus. For example in the cholesteric liquid crystal display device 3 described above, this may be achieved by arranging the electrode layers 14 and 15 to allow different areas of the liquid crystal material to be independently controlled, for example by subdividing one of the electrode layers 14 or 15 into separate electrodes.

Next, there will be described the background layer 4. The background layer 4 is not transparent so that it selectively absorbs and/or reflects any light passing through the cholesteric liquid crystal display device 3. Thus the light perceived by the viewer results from the combined effect of cholesteric liquid crystal display device 3 and the background layer 4 combine. For example, the background layer 4 may create different shades or colours for the background and/or influence the colour of the reflective material by adding a second reflective colour. The background layer 4 may be a layer affixed directly to the rear of the cholesteric liquid crystal display device 3, for example a layer of paint of a layer of material bonded to the background layer 4.

In another option cholesteric liquid crystal display device 3 can contain two or more areas of different colour which can be driven independently. In this case the liquid crystal layer 11 may be divided by glue seals into several areas, each area having its own filling hole which is used to inject the specific colour liquid crystal into that area. This is a known possibility for LCD manufacture, although rarely used in common practice. In this way several colours can be shown in the same tile in different areas.

In another option, a cholesteric liquid crystal display device 3 can consist of two cells 10. For example one cell 10 containing a blue liquid crystal and another cell 10 contains an orange liquid crystal. With a black background to the back of the two cells and the cells 10 laminated together the cholesteric liquid crystal display device 3 can be switched between white, black, blue and orange. Cells with other colour combinations can also be used as can more cells 10 in the stack such as red, green and blue cells 10, thus giving many colour combinations.

Variations in the cholesteric liquid crystal display device 3 from that described above are possible, including variations not in accordance with the decorative tile disclosed in British Application No. 1019213.6. In one type of variation, the cholesteric liquid crystal display device 3 does not include an image on the front substrate 2, or the front substrate 2 is omitted altogether Similarly, the cholesteric liquid crystal display device 3 may be applied to different uses from a decorative tile.

A possible implementation of the control circuit 30 is shown in FIG. 8 and will now be described.

The control circuit 30 comprises a microprocessor 31 that implements a control process to decide on the desired operation of the cholesteric liquid crystal display device 3. The control circuit 30 includes a wireless receiver 32 arranged to receive control signals wirelessly (e.g. by IR or RF) from an external control unit that allow the desired operation to be specified. The received control signals are supplied to the microprocessor 31 which implements the control process on the basis thereof.

The control circuit 30 includes a driver circuit 33 that generates drive signals that are supplied to the cholesteric liquid crystal display device 3. The microprocessor 31 supplies a data signal representing the desired operation to the driver circuit 33 which generates the drive signals in response thereto.

The control circuit 30 also includes voltage level converter 34 that receives power from an external power supply 35 and generates a supply voltage of relatively low voltage supplied to the microprocessor 31 and to the wireless receiver 32 and one or more supply voltages of relatively high voltage supplied to the driver circuit 33.

There will now be described a drive scheme for the cholesteric liquid crystal display device 3 providing a change from a bright state to a dark state, implemented by generation and supply of an appropriate drive signal in the control circuit 30.

By way of comparison, FIG. 9 illustrates a drive scheme not in accordance with the present invention, in which the drive signal of FIG. 1 is applied to a change from a bright state to a dark state. In this comparison example, the drive signal 100 shown in FIG. 1, consisting of the initial pulses 106 to drive the liquid crystal material into the homeotropic state, the relaxation period 107 and the selection pulses 108, is applied at the beginning of each of a plurality of successive periods 40 to drive the cholesteric liquid crystal material into a stable state in the remainder 41 of the period 40, which may be of any length and may be significantly longer than the drive signal 100. The magnitude of the selection pulses 108 is increased in each successive period 40 so that the cholesteric liquid crystal material has a successively decreasing reflectivity in the remainder 41 of each period 40. By use of appropriate selection pulses 108, this is effective to cause a change from a bright state to a dark state.

However, this drive scheme causes a fluctuation in the reflectivity at each transition in the brightness, of the type described above. During the drive signal 100 at the transition this fluctuation is perceived, for example as shown in region 42, as a very dark ‘blink’, a bright ‘flash’, and finally a dark ‘bounce’ before the final brightness is reached in the remainder 41 of the period 40. Although this is perceived only when there is a transition in the brightness, in many applications it is undesirable. For example when the cholesteric liquid crystal display device 3 is used as a decorative tile, the fluctuation is distracting or even annoying to the viewer.

FIG. 10 illustrates which is a modification of the drive scheme shown in FIG. 9 considered by the present inventors but not in accordance with the present invention. This drive scheme was developed based on the appreciation that it is possible to drive the cholesteric liquid crystal in successive periods 40b after the first period 40a into stable states of decreasing reflectivity merely by applying a selection pulse 108. This is because once the cholesteric liquid crystal material is in the planar state or a mixed state, it is possible to apply a selection pulse 108 that is effective to change the state of the cholesteric liquid crystal material into a mixed state of lower reflectivity, that is with a higher proportion of material in the focal conic state.

Thus, in the drive scheme shown in FIG. 10, the drive signal 100 shown in FIG. 1, consisting of the initial pulses 106, the relaxation period 107 and the selection pulses 108, is applied at the beginning of the first period 40a to drive the cholesteric liquid crystal material into a first stable state of high reflectivity in the remainder 41 of the first period 40a. However, a drive signal consisting of only the selection pulses 108 (i.e. without the initial pulses 106 and the relaxation period 107) is applied at the beginning of the further periods 40b. Again, the magnitude of the selection pulses 108 is increased in each successive further period 40b so that the cholesteric liquid crystal material has a successively decreasing reflectivity in the remainder 41 of the further periods 40b. By use of appropriate selection pulses 108, this is effective to cause a change from a bright state to a dark state.

This modified drive scheme of FIG. 10 causes less fluctuation than the drive scheme of FIG. 9 in that in the further periods 40b it avoids the fluctuation arising from the initial pulses 106 and the relaxation period 107 that is perceived as a very dark ‘blink’ followed by a bright ‘flash’. However, there is still a fluctuation in the reflectivity at each transition in the brightness in each of the further periods 40b arising from the relaxation of the cholesteric liquid crystal material after removal of the selection pulses 108. This is perceived, for example as shown in region 42, as a dark ‘bounce’ before the final brightness is reached in the remainder 41 of the further periods 40. Although this fluctuation is less significant than that resulting from the drive scheme of FIG. 9, it is still noticeable and undesirable in many applications, for example when the cholesteric liquid crystal display device 3 is used as a decorative tile.

FIG. 11 illustrates a drive scheme in accordance with the present invention. In this drive scheme, the drive signal 50 consists of the following components in successive periods 61, 62, 63₁ to 63ₙ, and 64.

The drive signal 50 starts with two initial pulses 51 in period 61 that drive the cholesteric liquid crystal material into the homeotropic state. This is equivalent to the initial pulses 106 in the drive signal 100 of FIG. 1. The magnitude of the initial pulses 51 is sufficiently high to select the homeotropic state, for example of the order of 30V or 40V in a cholesteric liquid crystal display device 3 of typical construction.

In this example, the two initial pulses 51 are of opposite polarity to provide dc balancing, but this is not essential and in general the number of initial pulses 51 may be varied provided there is at least one initial pulse 51. In this example, the initial pulses 51 are square waves, which is convenient for generation in the control circuit 30, but in principal the initial pulses 51 could have a different waveform.

Following initial pulses 51, the drive signal 50 comprises a relaxation period 52 in period 62 during which the cholesteric liquid crystal material is allowed to relax into the planar state. This is equivalent to the relaxation period 107 in the drive signal 100 of FIG. 1. The relaxation period 52 can be simply a zero voltage, although in principle it could alternatively consist of one or more low voltage pulses.

Following relaxation period 52, the drive signal 50 differs from the drive signal 100 of FIG. 1, in particular comprising a drive signal comprising a drive sequence consisting of a group 53 of pulses 54 in each of n successive period 63₁ to 63ₙ. The groups 53 are shown schematically in FIG. 11 and the form of the pulses 54 within in single group 53 is illustrated in FIG. 12.

In this example, there are illustrated eight pulses 54 of opposite polarity with no gaps between the pulses 54, but this is not essential. In general, there may be any number of pulses 54 in a group 53, or the group 53 may be replaced by a single pulse 54. However, it is advantageous to form the group 53 as an even number of pulses of opposite polarity in order to provide de balancing. The pulses 54 may be of any length, but are typically sufficiently short to avoid flicker and provide dc balancing over two successive pulses of opposite polarity, for example each pulse 54 having a length of the order of 10 ms. In this example, the pulses 54 are square waves, which is convenient for generation in the control circuit 30, but in principal the pulses 54 could have a different waveform.

The voltages of the pulses 54 within each group 53 are of the same magnitude, and hence of the same root mean square (rms) voltage, because the absence of gaps between the pulses 54 means that the rms voltage determined over the cycle period of the pulses 54 is equal to the peak voltage. The magnitude of the voltages, and hence the rms voltage, of the pulses 54 of each successive group 53 increases. Thus, considering the drive sequence of all the pulses 54 in all the groups 53, the magnitude of the voltages, and hence the rms voltage, of the pulses 54 increases monotonically, that is staying the same within each group 53 and increasing in steps between the groups 53. This drive sequence drives the cholesteric liquid crystal material continuously into a transient state, which is described further below together with the implications on the magnitude of the voltages of the pulses 54.

Following the drive sequence consisting of a group 53 of pulses 54, the drive signal 50 comprises two final pulses 55 that drive the cholesteric liquid crystal material into the focal conic state. The magnitude of the final pulses 55 is selected, relative to the magnitude of the pulses 54 in the final group 53, to select the focal conic state, for example being larger than the magnitude of the pulses 54 in the final group 53 and being of the order of 25V in a cholesteric liquid crystal display device 3 of typical construction. After the final pulses 55, the drive signal 50 may cease so that the cholesteric liquid crystal material remains in the stable focal conic state or alternatively, the drive signal 50 may be immediately repeated.

In this example, the two final pulses 55 are of opposite polarity to provide dc balancing, but this is not essential and in general the number of final pulses 55 may be varied provided there is at least one final pulse 55. In this example, the final pulses 55 are square waves, which is convenient for generation in the control circuit 30, but in principal the final pulses 55 could have a different waveform.

However, the final pulses 55 are optional and may be omitted, in which case there are several options. A first option is for the drive signal 50 to cease so that the cholesteric liquid crystal material relaxes into a stable state that is selected by the pulses 54 in the final group 53. A second option is for the drive signal 50 to be immediately repeated.

The effect of the drive signal 50 is as follows.

In period 61, the cholesteric liquid crystal material is driven into the homeotropic state having a reflectivity lower than that of any stable state. In period 62, the cholesteric liquid crystal material relaxes into planar state having a reflectivity that is high, being at maximum for the material. This is the same as for the drive signal 100 of FIG. 1.

In each of the n successive period 63₁ to 63ₙ the drive sequence consisting of groups 53 of pulses 54 drives the cholesteric liquid crystal material into a transient state whose reflectivity is lower than that of the planar state and reduces in each of the n successive period 63₁ to 63ₙ . This phenomenon is observed to occur with the following characteristics.

It is observed that the reduction in reflectivity occurs in the first period 63₁ even when the magnitude, and hence the rms voltage determined over the cycle period, of the pulses 54 in the first group 53 (or a plural number of groups 53, or for more general sequences, one or more pulses 54) is less than that required to drive the material from the planar state into a mixed state of lower reflectivity, for example less than the minimum possible level of a selection pulse 108 of the drive signal 100 of FIG. 1. For example, for a cholesteric liquid crystal display device 3 of typical construction for which a selection pulse 108 of the drive signal 100 of FIG. 1 is required to have a magnitude greater than a threshold of, say, 8V-10V, it is observed that the pulses 54 in the first group 53 cause a reduction in the reflectivity when they have a lower magnitude, for example around 5V.

Furthermore, the reflectivity is observed to reduce in correspondence with the root mean square of the voltage of the pulses 54, that is in this case also in correspondence with the magnitude of the voltage of the pulses 54. Thus, the reflectivity reduces monotonically, that is staying the same within each group 53 and increasing in steps between the groups 53 as illustrated in FIG. 11. Furthermore the reduction in reflectivity occurs without any fluctuation and in particular without any perceived ‘bounce’ as follows the selection pulses 108 of the drive signal 100 of FIG. 1. To illustrate this effect, FIG. 13 shows a scope trace for the drive signal 50 at a transition between two groups 53 of pulses 54 and the resultant optical response, measured using a photodiode, of a typical cholesteric liquid crystal display device 3 (of the same type as FIG. 2). After the transition of the pulse amplitude of the selection pulses 108, the reflectivity exhibits a decrease with a gradual decay without any overshoot that might be perceived as a ‘bounce’. This compares favourable with the observations shown in FIG. 2.

Thus, the drive scheme of FIG. 11 achieves a change in the brightness of the cholesteric liquid crystal display device 3 from a bright state to a dark state in successive steps in the n successive period 63₁ to 63ₙ, but with reduced fluctuations as compared to the drive schemes of FIGS. 9 and 10. The drive scheme of FIG. 11 avoids the fluctuations that would be perceived with the drive scheme of FIG. 12 at each of the second and subsequent transitions in the brightness, that is a very dark ‘blink’, a bright ‘flash’ and a dark ‘bounce’. As with the drive scheme of FIG. 10, the drive scheme of FIG. 11 does have a fluctuation at its beginning, perceived as a very dark ‘blink’, but this is a single event that has a limited impact on the viewer. Furthermore, the drive scheme of FIG. 11 avoids the fluctuations that would be perceived with the drive scheme of FIG. 10 at each of the transitions in the brightness, that is a dark ‘bounce’, albeit requiring continuous application of the drive signal and hence having a higher power consumption than the drive schemes of FIG. 8 or FIG. 9.

The reduction in the degree of fluctuation allows the gradual change to occur with less distraction, or even annoyance, to a viewer. This is a benefit in many applications, including without restriction the use of the cholesteric liquid crystal display device 3 as a decorative tile.

In general, there may be any number of groups 53 of pulses 54. Increased numbers of groups 53 may allow the degree of change between two groups 53 to be reduced, thereby providing the perception of a more gradual fade in brightness. The size of the steps is chosen such that the changes in hue of the cholesteric liquid crystal material are below or close to the visual colour resolution of the eye. This produces a perceived gradual reduction in primary colour reflectivity. On the other hand, increased numbers of groups 53 also requires the control circuit 30 to generate larger numbers of voltage levels, which may be inconvenient. The overall length of any group 53 of pulses 54 may be freely selected depending on the period over which the fade in brightness is desired to occur.

It is further observed that the reflectivity spectrum maintains a peak at substantially the same wavelength as the planar state as follows.

As a comparative example, FIG. 14 shows reflectivity spectra obtained by supplying the drive signal 100 of FIG. 1, to a cholesteric liquid crystal display device 3 in which the cholesteric liquid crystal material is MDA003906 liquid crystal in a layer 11 of thickness 5 μm with SE7511 alignment layers, with varying selection pulses 108 to achieve different grey levels. The peak wavelength is maintained constantly at substantially the same wavelength as the planar state for higher reflectivity grey levels but moves towards shorter wavelengths at lower reflectivity. Fortunately the eye is less sensitive to hue at low reflectivity values so this shift is relatively unimportant. As the voltage of the selection pulses 108 that generates the static grey level is increased more domains are forced into the focal conic state and so the reflectivity of the device drops. At the same time the planar domains reduce in size and the distribution of angles of the liquid crystal helix axes is flattened. This provides a larger contribution to the reflection from helices at higher angles which reflect light centred on a lower wavelength. Hence the peak of the reflected light shifts towards shorter wavelengths.

FIG. 15 shows reflectivity spectra obtained by supplying the drive signal 50 of FIG. 11, during the drive sequence in each of the n successive period 63₁ to 63ₙ, to the same cholesteric liquid crystal display device 3 as for FIG. 14. This results in similar spectra to those of FIG. 14, in particular maintaining a peak at substantially the same wavelength as the planar state for higher reflectivity grey levels but moving towards shorter wavelengths at lower reflectivity. A secondary peak at lower wavelengths, also apparent in the spectra of FIG. 14, is slightly more pronounced.

FIG. 16 plots the position of peak wavelength observed in the spectra of FIG. 14 (labelled as “static”) and FIG. 15 (labelled as “fade”) against reflectance normalised to the planar state value. The wavelength shifts are similar for higher reflectance grey levels but as the ratio of planar to focal conic domains is modified in the case of FIG. 14 so the peak wavelength shifts more rapidly to shorter wavelengths.

In view of the observation that the reflectivity spectrum maintains a peak at substantially the same wavelength as the planar state, it is hypothesized that, in the n successive period 63₁ to 63ₙ, the groups 53 of pulses 54 disrupt the molecules from their helical arrangement in the planar state from their position whilst to a substantial extent maintaining the pitch length, so that the Bragg reflection continues but to a reduced degree. For this combination of liquid crystal and alignment layer there is no change in the distribution of helix angles i.e. no change in the direction of the Bragg reflection so the position of the peak in the spectra remains fixed. For different combinations of material of the liquid crystal layer 11 and alignment layers there may be different results depending on the relative interactions of the components. This hypothesis might be somewhat incorrect, but nonetheless the observed phenomenon of the reflectivity reducing in each of the n successive period 63₁ to 63ₙ is useful.

Various modifications to the drive scheme shown in FIG. 11 may be introduced to achieve the same effect.

One possible variation shown in FIG. 17 is to have gaps 56 between the pulses 54, provided that the gaps 56 are sufficiently short that the cholesteric liquid crystal material does not relax and remains in the transient state. As a result, the cholesteric liquid crystal material responds to the rms voltage of the pulses 54 and not to the individual components of the waveform. A suitable size for such gaps 56 may be determined for a cholesteric liquid crystal display device 3 by performing measurements such as those shown in FIGS. 2 and 13 to measure the time over which relaxation in the observed reflectivity occurs. However, for a typical cholesteric liquid crystal display device 3, it might be permissible to have gaps 56 of 1 ms or less. This may be achieved for example by having a cycle period of 1 ms or less, as the gaps cannot exceed the cycle period.

In the case that gaps 56 are present between the pulses 54, the transient state of the liquid crystal material is dependent on the rms voltage of the pulses 54 determined over the cycle period of the pulses 54 (i.e. the period from the start of one pulse 54 to the start of the next pulse 54), provided that the aforementioned requirement on the gaps 56 is met. Thus, if the pulses 54 are of the same length and the cycle period is constant, then the magnitude of the voltages of the pulses 54 of each successive group 53 increases in order to increase the rms voltage. For pulse 54 that are square waves, the rms voltage Vrms of the x-th a pulse 54 of magnitude Vp and length tx may be determined over the cycle period Tp as Vp√d, where d is the duty cycle equal to (tx/Tp).

Alternatively, pulse width modulation may be used to change the rms voltage of the pulses 54 determined over the cycle period of the pulses 54, so that the rms voltage of the pulses 54 within each group 53 are the same, and the rms voltage of the pulses 54 of each successive group 53 increases. This has the same effect on the cholesteric liquid crystal material as described above for the drive scheme of FIG. 11. The advantage of using pulse width modulation is that it allows the use of a single voltage level for all the pulses 54 which simplifies the control circuit 30. However, as the power consumption depends on the frequency at which the capacitance of the cell 10 is charged and discharged, introducing gaps between the pulses 54 is likely to consume more power.

In one example of such pulse width modulation, the magnitude of the voltage of the pulses 54 in the sequence is constant, the cycle period is constant, the width of the pulses 54 within each group 53 is the same and the width of the pulses of each successive group 53 increases.

A specific example of the use of pulse width modulation is as follows.

The magnitude of the pulses 54 in the drive sequence and the initial pulses may be selected to be the same at a level well above the transition voltage V4 at which the cholesteric liquid crystal material is driven into the homeotropic state, for example 40V above but close to V4, for example 30V. In another alternative that utilises separate voltages for the initial pulses 51 and the pulses 54 in the drive sequence, the magnitude of the pulses 54 in the drive sequence may be selected to be close to the voltage required to drive the material from the planar state to the focal conic state, say 25V. If present, the final pulses 55 may have the same voltage of say 25V.

To achieve the desired fade the drive sequence provides rms voltages, determined over the cycle period of the pulses 54, that change between approximately 4V to 12V, depending on the liquid crystal material, the alignment layer and the construction of the cell 10. The following table indicates the required duty cycle of the pulses 54 to achieve these rms voltages at different magnitudes of the pulses 54.

| | Duty | Duty | Duty |
|---|---|---|---|
| Vrms | cycle at 40 V | cycle at 30 V | cycle at 25 V |
| 4 | 0.01 | 0.018 | 0.026 |
| 12 | 0.09 | 0.16 | 0.23 |
| 25 | 0.39 | 0.69 | 1.0 |

The use of pulses 54 in the drive sequence is straightforward to implement in the control circuit 30. In its simplest embodiment, the control circuit 30 may be a low cost, digital circuit that provides only 4 or 5 bits resolution to a D/A converter. Higher resolution produced by using more control bits in the D/A circuit may be provided, if necessary, to give smaller brightness changes for combinations of cholesteric liquid crystal material that produce neutral colours for which the sensitivity of the eye provides more colour discrimination.

However, in principal, the pulses 54 of the drive sequence could be replaced by a continuous voltage waveform, more suitable for implementation with analogue electronics. In this case, during the drive sequence it remains the case that the root mean square voltage of the drive signal, determined over periods within which the cholesteric liquid crystal does not relax, increases monotonically. This causes the same effect of correspondingly reducing the reflectivity of the cholesteric liquid material. If the drive sequence is a continuous voltage waveform, then it is desirable for the waveform to be shaped with alternating polarity that provides dc balancing.

1. A method of driving a cholesteric liquid crystal display device which comprises at least one cell comprising a layer of cholesteric liquid crystal material and an electrode arrangement capable of applying a drive signal across at least one area of the layer of cholesteric liquid crystal material, the method comprising supplying a drive signal to the electrode arrangement that comprises:
at least one initial pulse that drives the cholesteric liquid crystal material into the homeotropic state;
a relaxation period that allows the cholesteric liquid crystal material to relax into the planar state; and
a drive sequence during which the root mean square voltage of the drive signal, determined over periods within which the cholesteric liquid crystal does not relax, increases monotonically and correspondingly reduces the reflectivity of the cholesteric liquid material.

2. The method according to claim 1, wherein the drive sequence comprises a sequence of pulses, between which there are no gaps or gaps sufficiently short that the cholesteric liquid crystal does not relax, wherein the root mean square voltage of the pulses, determined over cycle periods of the pulses, increases monotonically.

3. The method according to claim 2, wherein the drive sequence comprises a sequence of pulses of alternating polarity.

4. The method according to claim 2, wherein one or more pulses at the beginning of the sequence have root mean square voltage that is less than the root mean square voltage required to drive the cholesteric liquid crystal material from the planar state to the focal conic state.

5. The method according to claim 2, wherein the drive sequence of pulses comprises a series of groups of a plural number of pulses, wherein the root mean square voltage of the pulses within each group is the same, and the root mean square voltage of the pulses of each successive group increases.

6. The method according to claim 5, wherein the series of groups comprises at least two groups.

7. The method according to claim 5, wherein the plural number is even.

8. The method according to claim 2, wherein
the drive sequence comprises a sequence of pulses between which there are no gaps, and
the magnitude of the voltage of the pulses increases monotonically so that the root mean square voltage of the pulses, determined over cycle periods of the pulses, increases monotonically.

9. The method according to claim 2, wherein
the drive sequence comprises a sequence of pulses between which there are gaps sufficiently short that the cholesteric liquid crystal does not relax,
the magnitude of the voltage of the pulses in the sequence is constant,
the cycle period is constant, and
the width of the pulses increases monotonically so that the root mean square voltage of the pulses, determined over cycle periods of the pulses, increases monotonically.

10. The method according to claim 2, wherein the pulses are square wave pulses.

11. The method according to claim 1, wherein the drive signal applied by the electrode arrangement further comprises, following the drive sequence, at least one final pulse that drives the cholesteric liquid crystal material into the focal conic state.

12. The method according to claim 1, wherein the cholesteric liquid crystal display device further comprises:
in front of the at least one cell, a transparent front substrate carrying a foreground image, the foreground image having varying transparency across its area; and
behind the at least one cell, a background layer that is not transparent.

13. A cholesteric liquid crystal display device comprising:
at least one cell comprising a layer of cholesteric liquid crystal material and an electrode arrangement capable of applying a drive signal across at least one area of the layer of cholesteric liquid crystal material; and
a drive circuit arranged to supply a drive signal to the electrode arrangement that comprises:
at least one initial pulse configured to drive the cholesteric liquid crystal material into the homeotropic state;
a relaxation period configured to allow the cholesteric liquid crystal material to relax into the planar state; and
a drive sequence during which the root mean square voltage of the drive signal, determined over a period within which the cholesteric liquid crystal does not relax, increases monotonically and configured to correspondingly reduce the reflectivity of the cholesteric liquid material.

14. The cholesteric liquid crystal display device according to claim 13, wherein the drive sequence comprises a sequence of pulses, between which there are no gaps or gaps sufficiently short that the cholesteric liquid crystal does not relax, wherein the root mean square voltage of the pulses, determined over cycle periods of the pulses, increases monotonically.

15. The cholesteric liquid crystal display device according to claim 14, wherein the drive sequence comprises a sequence of pulses of alternating polarity.

16. The method according to claim 14, wherein one or more pulses at the beginning of the sequence have root mean square voltage that is less than the root mean square voltage required to drive the cholesteric liquid crystal material from the planar state to the focal conic state.

17. The cholesteric liquid crystal display device according to claim 14, wherein the drive sequence of pulses comprises a series of groups of a plural number of pulses, wherein the root mean square voltage of the pulses within each group is the same, and the root mean square voltage of the pulses of each successive group increases.

18. The cholesteric liquid crystal display device according to claim 16, wherein the series of groups comprises at least two groups.

19. The cholesteric liquid crystal display device according to claim 17, wherein the plural number is even.

20. The cholesteric liquid crystal display device according to claim 14, wherein
the drive sequence comprises a sequence of pulses between which there are no gaps, and
the magnitude of the voltage of the pulses increases monotonically so that the root mean square voltage of the pulses, determined over cycle periods of the pulses, increases monotonically.

21. The cholesteric liquid crystal display device according to claim 14, wherein
the drive sequence comprises a sequence of pulses between which there are gaps sufficiently short that the cholesteric liquid crystal does not relax,
the magnitude of the voltage of the pulses in the sequence is constant, the cycle period is constant, and
the width of the pulses increases monotonically so that the root mean square voltage of the pulses, determined over cycle periods of the pulses, increases monotonically.

22. The cholesteric liquid crystal display device according to claim 14, wherein the pulses are square wave pulses.

23. The cholesteric liquid crystal display device according to claim 13, wherein the drive signal applied by the electrode arrangement further comprises, following the drive sequence, at least one final pulse that is configured to drive the cholesteric liquid crystal material into the focal conic state.

24. The cholesteric liquid crystal display device according to claim 13, further comprising:
in front of the at least one cell, a transparent front substrate carrying a foreground image, the foreground image having varying transparency across its area; and
behind the at least one cell, a background layer that is not transparent.
